(19) United States
(12) Patent Application Publication
(10) Pub. No.: US 2016/0076550 A1
(43) Pub. Date: Mar. 17, 2016

(54) Redundant ESP Seal Section Chambers

(71) Applicant: GE Oil & Gas ESP, Inc., Oklahoma City, OK (US)

(72) Inventors: Charles Collins, Oklahoma City, OK (US); James Le, Oklahoma City, OK (US)

(73) Assignee: GE OIL & GAS ESP, INC., Oklahoma City, OK (US)

(21) Appl. No.: 14/856,738

(22) Filed: Sep. 17, 2015

Related U.S. Application Data
(60) Provisional application No. 62/051,392, filed on Sep. 17, 2014.

(51) Int. Cl. F04D 29/10; F16J 15/00; F16J 15/52; E21B 43/12; F16J 15/447

(52) U.S. Cl. CPC F04D 29/106; E21B 43/128; F16J 15/447; F16J 15/52; F16J 15/002

(57) ABSTRACT

A seal section for use in a downhole submersible pumping system includes redundant fluid separation mechanisms. The fluid separation mechanisms are bag seal assemblies, labyrinth seals, pistons and bellows. The seal section further includes a shaft, one or more shaft seals and a bag support tube. An annulus between the shaft and the shaft support tube provides a fluid flow path from a motor to the fluid separation mechanisms.

### RELATED APPLICATIONS

This application claims the benefit of U.S. Patent Application Ser. No. 62/051,392, filed Sep. 17, 2014, entitled “Redundant ESP Seal Section Chambers,” the disclosure of which is herein incorporated by reference.

### FIELD OF THE INVENTION

This invention relates generally to the field of submersible pumping systems, and more particularly, but not by way of limitation, to an improved seal section.

### BACKGROUND

Submersible pumping systems are often deployed into wells to recover petroleum fluids from subterranean reservoirs. Typically, the submersible pumping system includes a number of components, including one or more fluid filled electric motors coupled to one or more high performance pumps. Each of the components and sub-components in a submersible pumping system is engineered to withstand the inhospitable downhole environment, which includes wide ranges of temperature, pressure and corrosive well fluids.

Components commonly referred to as “seal sections” protect the electric motors and are typically positioned between the motor and the pump. In this position, the seal section provides several functions, including transmitting torque between the motor and pump, restricting the flow of wellbore fluids into the motor, protecting the motor from axial thrust imparted by the pump, and accommodating the expansion and contraction of motor lubricant as the motor moves through thermal cycles during operation. Prior art seal sections employ a single seal bag, bellows or labyrinth chamber to accommodate the volumetric changes and movement of fluid in the seal section while providing a positive barrier between clean lubricant and contaminated wellbore fluid.

While generally acceptable, prior art seal sections often fail to isolate contaminated well fluids from clean lubricants. As wellbore fluids are drawn into the seal section, sand and other particulate solids may accumulate and compromise the integrity of the seal mechanism within the seal section. Accordingly, there exists a need for an improved design that is more resistant to contamination and wear caused by solid particles. It is to this and other deficiencies in the prior art that the present invention is directed.

### SUMMARY OF THE INVENTION

In exemplary embodiments, a seal section for use in a downhole submersible pumping system includes redundant fluid separation mechanisms. The fluid separation mechanisms are selected from the group consisting of bag seal assemblies, labyrinth seals, pistons and bellows. The seal section may further include a shaft, one or more shaft seals and a bag support tube. An annulus between the shaft and the shaft support tube provides a fluid flow path from a motor to the fluid separation mechanisms. In another aspect, the embodiments of the seal section are incorporated within a downhole pumping system

### BRIEF DESCRIPTION OF THE DRAWINGS

FIG. 1 is an elevational view of a submersible pumping system constructed in accordance with exemplary embodiments.

FIG. 2 is a cross-sectional view of a seal section for use with the submersible pumping system of FIG. 1.

FIG. 3 is a cross-sectional view of a seal section for use with the submersible pumping system of FIG. 1.

FIG. 4 is a cross-sectional view of a seal section for use with the submersible pumping system of FIG. 1.

FIG. 5 is a cross-sectional view of a seal section for use with the submersible pumping system of FIG. 1.

### DETAILED DESCRIPTION

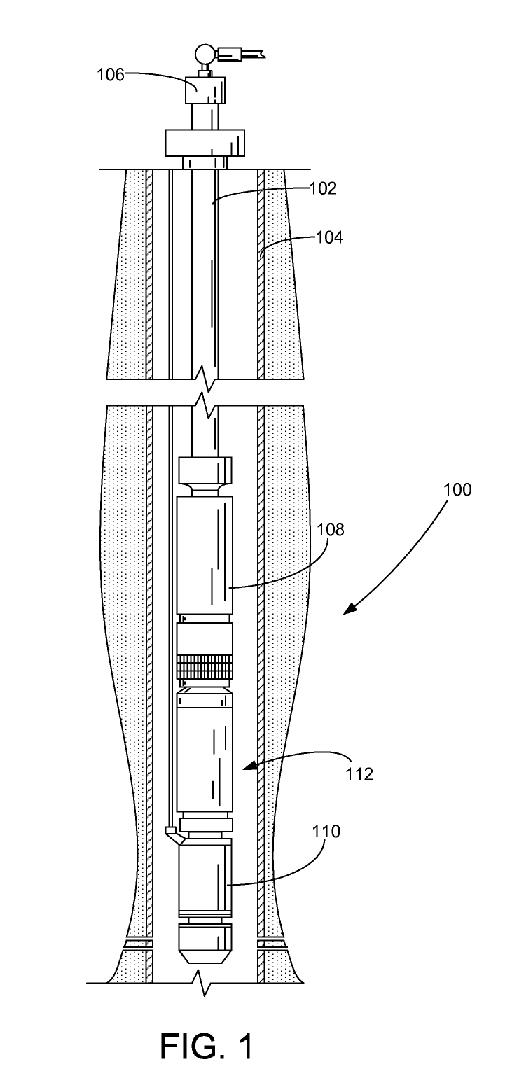

In accordance with an exemplary embodiment, FIG. 1 shows an elevational view of a pumping system 100 attached to production tubing 102. The pumping system 100 and production tubing 102 are disposed in a wellbore 104, which is drilled for the production of a fluid such as water or petroleum. As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the pumping system 100 can also be used to move other fluids. It will also be understood that, although each of the components of the pumping system 100 are primarily disclosed in a submersible application, some or all of these components can also be used in surface pumping operations.

The pumping system 100 includes a combination of a pump assembly 108, a motor assembly 110 and a seal section 112. The motor assembly 110 is an electrical motor that receives power from a surface-mounted motor control unit (not shown). When electrically energized, the motor assembly 110 drives a shaft that causes the pump assembly 108 to operate. The seal section 112 shields the motor assembly 110 from mechanical thrust produced by the pump assembly 108 and provides for the expansion of motor lubricants during operation. The seal section 112 also isolates the motor assembly 110 from the wellbore fluids passing through the pump assembly 108. Although only one of each component is shown, it will be understood that more can be connected when appropriate. It may be desirable to use tandem-motor combinations, multiple seal sections, multiple pump assemblies or other downhole components not shown in FIG. 1. For example, in certain applications it may be desirable to place a seal section or pressure compensating chamber 112 below the motor assembly 110.

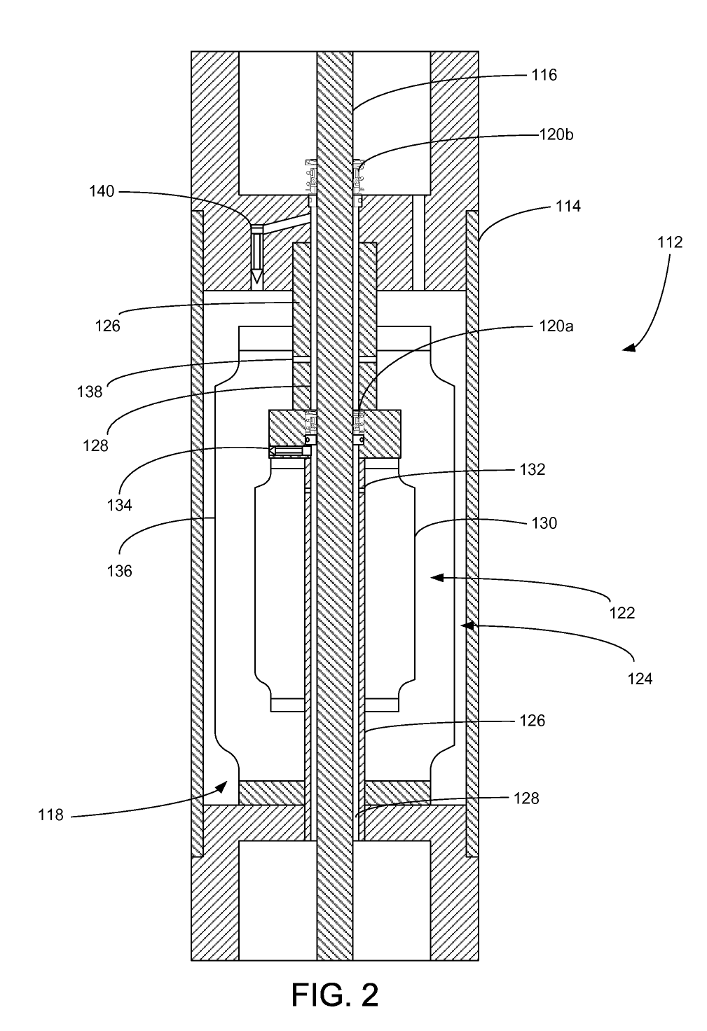

Referring now to FIG. 2, shown therein is a cross-sectional view of the seal section 112. The seal section 112 includes a housing 114, a shaft 116, and a plurality of fluid separation mechanisms 118. The shaft 116 transfers mechanical energy from the motor assembly 110 to the pump assembly 108. The housing 114 is configured to protect the internal components of the seal section 112 from the exterior wellbore environment. The seal section 112 further includes a plurality of shaft seals 120 that prevent the migration of fluid along the shaft 116. In some embodiments, the shaft seals 120 are mechanical seals or spring-biased lip seals. In the embodiment depicted in FIG. 2, there are two shaft seals 120a, 120b in the seal section 112.

In the embodiment depicted in FIG. 2, the fluid separation mechanisms 118 include an interior bag seal assembly 122 and an exterior bag seal assembly 124. The interior bag seal assembly 122 is contained within the exterior bag seal assembly 124, which is in turn contained within the housing 114. The interior bag seal assembly 122 and exterior bag seal assembly 124 are each supported by a bag support tube 126 that surrounds the shaft 116. The space between the exterior of the shaft 116 and the interior of the bag support tube 126 provides an annulus 128 through which fluids can pass.

The interior bag seal assembly 122 includes a first seal bag 130, fluid ports 132 and one or more first check valves 134. In some embodiments, the first seal bag 130 is constructed from a durable material. Suitable materials include fluoropolymers and highly saturated nitrile rubber. The fluid ports 132 place the interior of the first seal bag 130 in communication with the annulus 128. The first check valve 134 is in fluid communication with the annulus 128 and also the interior of the exterior bag seal assembly 124. The first check valve 134 is biased in a closed position. When a predetermined threshold pressure is applied to the first check valve 134, the first check valve 134 opens and allows fluid from the annulus 128 to pass into the exterior bag seal assembly 124.

The exterior bag seal assembly 124 includes a second seal bag 136, fluid ports 138 and a second check valve 140. In exemplary embodiments, the second seal bag 136 is constructed from a durable material. Suitable materials include fluoropolymers and highly saturated nitrile rubber. The fluid ports 138 place the interior of the second seal bag 136 in communication with the annulus 128. The second check valve 140 is in fluid communication with the annulus 128 above the shaft seal 120a and also directly, or indirectly through the pump 108, with the wellbore 104. The second check valve 140 is biased in a closed position. When a predetermined threshold pressure is applied to the second check valve 140, the second check valve 140 opens and allows fluid from the annulus 128 to pass into the space around the exterior of the second seal bag 136, above the shaft seal 120a, and into the wellbore 104 or pump 108.

During use, fluid from the motor 110 migrates up the shaft 116 in the annulus 128 to fluid ports 132. The shaft seal 120a prevents the fluid from passing further along the annulus 128 and the fluid passes through the fluid ports 132 into the interior of the first seal bag 130. As the first seal bag 130 expands to accommodate the fluid, the pressure inside the first seal bag 130 increases. At the point at which the pressure inside the first seal bag 130 exceeds the threshold pressure for the first check valve 134, the first check valve 134 temporarily opens to allow fluid to pass through to the interior of the second seal bag 136. Once the pressure has been relieved the first check valve 134 closes. Over time, the fluid in the second seal bag 136 may accumulate to a point at which the pressure inside the second seal bag 136 exceeds the threshold pressure for the second check valve 140. At that point, the second check valve 140 opens and fluid from the second seal bag 136 travels through the fluid ports 138 into the annulus 128, through the open second check valve 140, into the space around the exterior of the second seal bag 136 and into the wellbore 104 or pump 108.

As depicted in FIG. 2, the first seal bag 130 and second seal bag 136 operate in series. Fluid must pass through the first seal bag 130 before it can pass into the second seal bag 136. In an alternative embodiment, the shaft seal 120a is removed and fluid is allowed to pass through the annulus 128 between the first seal bag 130 and the second seal bag 136. In this configuration, the first seal bag 130 and the second seal bag 136 operate in a parallel configuration to provide additional seal volume, without the redundancy of the fluid separation mechanisms 118 operating in a serial configuration.

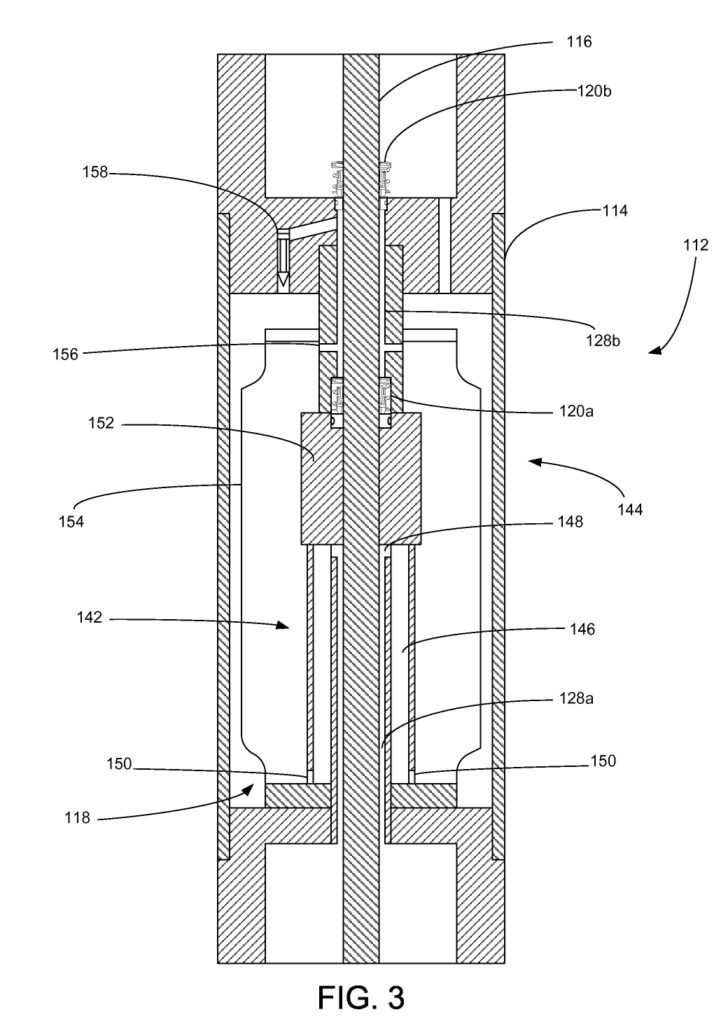

Turning to FIG. 3, shown therein is another embodiment of the seal section 112. In the embodiment depicted in FIG. 3, the seal section 112 includes two fluid separation mechanisms 118 that include a labyrinth seal 142 contained within a seal bag assembly 144. The internal labyrinth seal 142 includes a labyrinth chamber 146, inlet ports 148, outlet ports 150 and a cap 152. The inlet ports 148 provide a fluid flow path from a lower annulus 128a to the labyrinth chamber 146. The outlet ports 150 provide a fluid path from the labyrinth chamber 146 to the seal bag assembly 144. The cap 152 and shaft seal 120a prevent fluid from bypassing the labyrinth seal 142 along the annulus 128.

The seal bag assembly 144 includes a seal bag 154, discharge ports 156 and a check valve 158. In some embodiments, the seal bag 154 is constructed from a durable material. Suitable materials include fluoropolymers and highly saturated nitrile rubber. The interior of the seal bag 154 is placed in fluid communication with the check valve 158 through the discharge ports 156 and upper annulus 128b. The check valve 158 is configured to provide one-way flow in response to a fluid pressure in excess of a predetermined threshold pressure.

During use, fluid travels up the shaft 116 inside the lower annulus 128a into the labyrinth seal 142. The fluid is forced through inlet ports 148 into the labyrinth chamber 146. Solids and other particulates are trapped at the bottom of the labyrinth chamber 146. Fluid is discharged from the labyrinth chamber 146 through the outlet ports 150 into the interior of the seal bag 154. When the pressure inside the seal bag 154 exceeds the predetermined threshold pressure of the check valve 158, the check valve 158 temporarily opens and fluid from the seal bag 154 is expelled through the discharge ports 156, upper annulus 128b and check valve 158 into the wellbore 104 or the pump 108.

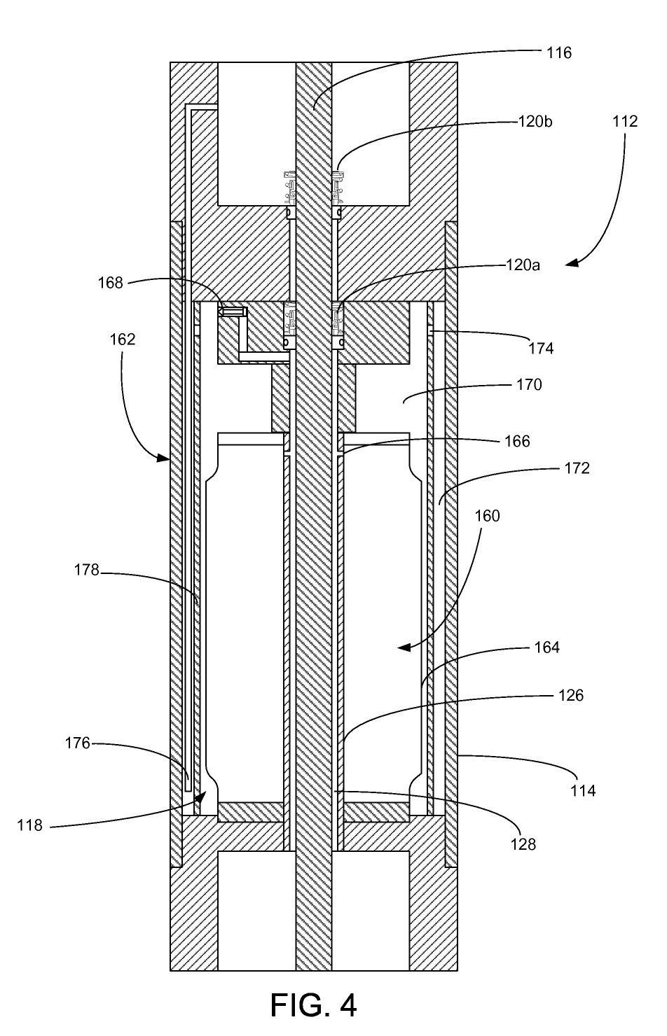

Turning to FIG. 4, shown therein is yet another embodiment of the seal section 112. In the embodiment depicted in FIG. 4, the seal section 112 includes two fluid separation mechanisms 118 that include a seal bag assembly 160 contained within a labyrinth seal 162. The seal bag assembly 160 includes a seal bag 164, fluid ports 166 and a check valve 168. The fluid ports 166 place the interior of the seal bag 164 in fluid communication with the annulus 128 between the bag support tube 126 and shaft 116. In some embodiments, the seal bag 164 is constructed from a durable material. Suitable materials include fluoropolymers and highly saturated nitrile rubber. The check valve 168 is configured to provide one-way flow in response to a fluid pressure in excess of a predetermined threshold pressure. The shaft seal 120a prevents fluid from bypassing the check valve 168.

The labyrinth seal 162 includes an internal chamber 170, an external chamber 172, exchange ports 174, a discharge tube 176 and a division wall 178. The internal chamber 170 is defined by the annular space between division wall 178 and the seal bag 164. The external chamber 172 is defined by the annular space between the outside of the divisional wall 178 and the inside of the housing 114. The exchange ports 174 are positioned near the top of the division wall 178 and place the internal chamber 170 in fluid communication with the external chamber 172. The discharge tube 176 extends to the bottom of the external chamber 172 and places the external chamber 172 in fluid communication with the wellbore 104 or pump 108.

During use, fluid migrates along annulus 128 between the shaft 116 and the bag support tube 126 to seal bag 164 through the fluid ports 166. When the pressure of the fluid in the seal bag 164 exceeds the threshold pressure of the check valve 168, the check valve 168 temporarily opens and fluid is expelled from the seal bag assembly 160 into the labyrinth seal 162. As the fluid enters the internal chamber 170, solids are drawn by gravity to the bottom of the internal chamber 170 and clean fluid is allowed to pass through the exchange ports 174 into the external chamber 172. From the external chamber 172, fluids are allowed to pass through the discharge tube 176 into the wellbore 104 or pump 108.

Fluids from the wellbore 104 may be drawn into the seal section 112 through the discharge tube 176. Solid particles in fluids passing through the discharge tube 176 into the external chamber 172 are trapped at the bottom of the external chamber 172 before the fluid passes into the internal chamber 170. Remaining solid particles are trapped within the bottom of the internal chamber 170.

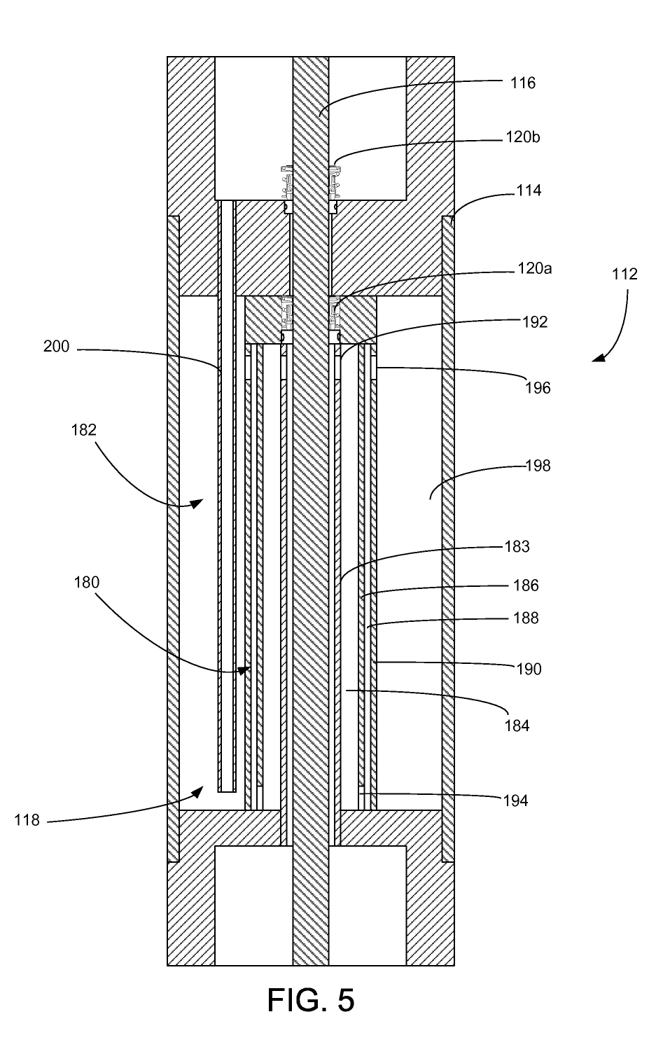

Turning to FIG. 5, shown therein is yet another embodiment of the seal section 112 in which two fluid separation mechanisms 118 include an internal labyrinth seal 180 contained within an external labyrinth seal 182. The internal labyrinth seal 180 includes a labyrinth support tube 183, a first labyrinth chamber 184, a division wall 186, a second labyrinth chamber 188, an outer wall 190, upper fluid exchange ports 192, lower fluid exchanger ports 194 and discharge ports 196.

The first labyrinth chamber 184 is defined by the annular space between the division wall 186 and the exterior of the labyrinth support tube 183. The second labyrinth chamber is defined by the annular space between the exterior of the division wall 186 and the interior of the outer wall 190. The inlet ports 192 extend through the labyrinth support tube 183 and place the first labyrinth chamber 184 in fluid communication with the annulus 128. The lower fluid exchange ports 194 extend through the division wall 186 near the bottom and place the first labyrinth chamber 184 in fluid communication with the second labyrinth chamber 188. The discharge ports 196 extend through the top of the outer wall 190 and place the second labyrinth chamber 188 in fluid communication with the external labyrinth seal 182.

The external labyrinth seal 182 is contained within the housing 114 and includes an external labyrinth chamber 198 and a discharge tube 200. The external labyrinth chamber 198 is defined as the annular space between the interior of the housing 114 and the exterior of the outer wall 190 of the internal labyrinth seal 180. The discharge tube 200 extends downward toward the bottom of the external labyrinth chamber 198. The shaft seal 120a prevents fluid from bypassing the internal labyrinth seal 180 and external labyrinth seal 182.

During a heating cycle, fluid enters the internal labyrinth seal 180 from the annulus 128 through inlet ports 192. Fluid is passed through the inlet ports 192 into the first labyrinth chamber 184, through the lower fluid exchange ports 194 into the second labyrinth chamber 184 and through the discharge ports 196 into the external labyrinth chamber 198 of the external labyrinth seal 182. From the external labyrinth chamber 198, fluid travels through the discharge tube 200. The redundant internal labyrinth seal 180 and external labyrinth seal 182 extends the useful life of the seal section 112 by ensuring that contaminates and solid particles are trapped within the external labyrinth chamber 198, second labyrinth chamber 188 and first labyrinth chamber 184.

Although the internal and external fluid separation mechanisms 118 have been disclosed as incorporating bag seal assemblies and labyrinth seals, it will be appreciated that other sealing mechanisms are employed in other embodiments. It may be desirable to use piston seals and bellows for one or both of the internal and external fluid separation mechanisms 118. For example, in one embodiment, the seal section 112 includes a movable piston seal for the internal fluid separation mechanism 118 and a bag seal assembly for the external fluid separation mechanism 118. In another embodiment, the internal fluid separation mechanism 118 includes an accordion-fold bellows seal that expands and contracts along a longitudinal axis within an external fluid separation mechanism 118 that includes a radially expanding bag seal assembly.

Thus, in various embodiments, the seal section 112 includes an internal fluid separation mechanism 118 contained within an external fluid separation mechanism 118, which is in turn contained within the housing 114. The internal fluid separation mechanism 118 is selected from bag seal assemblies, labyrinth seals, pistons and bellows. Likewise, the external fluid separation mechanism 118 is selected from bag seal assemblies, labyrinth seals, pistons and bellows. The internal and external fluid separation mechanisms 118 may be connected in series or parallel by modifying the flow path through the seal section 112.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A seal section for use in a downhole pumping system, the seal section comprising:
a first fluid separation mechanism; and
a second fluid separation mechanism contained within the first fluid separation mechanism.

2. The seal section of claim 1, wherein the first fluid separation mechanism is selected from the group consisting of bag seal assemblies, labyrinth seals, pistons and bellows.

3. The seal section of claim 2, wherein the second fluid separation mechanism is selected from the group consisting of bag seal assemblies, labyrinth seals, pistons and bellows.

4. The seal section of claim 1, wherein the first fluid separation mechanism is an exterior bag seal assembly and the second fluid separation mechanism is an interior bag seal assembly.

5. The seal section of claim 4, wherein the interior bag seal assembly comprises a first check valve in communication with the exterior bag seal assembly.

6. The seal section of claim 5, wherein the exterior bag seal assembly comprises a second check valve in communication with the wellbore.

7. The seal section of claim 4, wherein the exterior bag seal assembly and the interior bag seal assembly are connected in a series configuration.

8. The seal section of claim 4, wherein the exterior bag seal assembly and the interior bag seal assembly are connected in a parallel configuration.

9. The seal section of claim 1, wherein the first fluid separation mechanism is a bag seal assembly and the second fluid separation mechanism is a labyrinth seal.

10. The seal section of claim 9, wherein the labyrinth seal comprises:
a labyrinth chamber;
inlet ports connected to the labyrinth chamber;
outlet ports connected between the labyrinth chamber and the bag seal assembly; and
a cap.

11. The seal section of claim 1, wherein the first fluid separation mechanism is a labyrinth seal and the second fluid separation mechanism is a bag seal assembly.

12. The seal section of claim 1 wherein the first fluid separation mechanism is an external labyrinth seal and the second fluid separation mechanism is an internal labyrinth seal.

13. A seal section for use in a submersible pumping system, the seal section comprising:
a shaft;
a bag support tube surrounding the shaft;
an annulus between the shaft and the bag support tube;
a first fluid separation mechanism;
a second fluid separation mechanism contained within the first fluid separation mechanism; and
at least one shaft seal along the shaft contained within the first fluid separation mechanism.

14. The seal section of claim 13, wherein the first fluid separation mechanism is selected from the group consisting of bag seal assemblies and labyrinth seals.

15. The seal section of claim 14, wherein the second fluid separation mechanism is selected from the group consisting of bag seal assemblies and labyrinth seals.

16. The seal section of claim 13, wherein the first fluid separation mechanism is an exterior bag seal assembly and the second fluid separation mechanism is an interior bag seal assembly.

17. The seal section of claim 16, wherein the shaft seal diverts fluid from the annulus into the interior bag seal assembly.

18. A pumping system for deployment in a subterranean well, the pumping system comprising:
a motor;
a pump driven by the motor; and
a seal section between the motor and the pump, wherein the seal section comprises:
a first fluid separation mechanism; and
a second fluid separation mechanism contained within the first fluid separation mechanism.

19. The pumping system of claim 18, wherein the first fluid separation mechanism is selected from the group consisting of bag seal assemblies and labyrinth seals.

20. The pumping system of claim 18, wherein the second fluid separation mechanism is selected from the group consisting of bag seal assemblies and labyrinth seals.
